(19) United States
(12) Patent Application Publication
(10) Pub. No.: US 2009/0220669 A1
(43) Pub. Date: Sep. 3, 2009

(54) Low Trans Fat Oil Blend

(75) Inventors: William Lynn Lawrence, Hernando, MS (US); Richard Edward Moyers, Bartlett, TN (US)

Correspondence Address: FROST BROWN TODD, LLC, 2200 PNC CENTER, 201 E. FIFTH STREET, CINCINNATI, OH, 45202, US

(73) Assignee: ACH Food Companies, Inc., Corcova, TN (US)

(21) Appl. No.: 12/394,900

(22) Filed: Feb. 27, 2009

Related U.S. Application Data
(60) Provisional application No. 61/032,300, filed on Feb. 28, 2008.

(51) Int. Cl. A23D 7/00

(52) U.S. Cl. 426/607

(57) ABSTRACT

A low trans fat oil blend is prepared with partially hydrogenated vegetable oil, palm kernel oil and palm oil. The oil blend comprises: at least about 50% partially hydrogenated vegetable oil having a trans fatty acid content from about 2% to about 8%, from about 20% to about 50% palm kernel oil, and from about 5% to about 20% palm oil. The low trans fat oil blend can be used to make a low trans fat margarine, or a spread.

### PRIORITY CLAIM

This U.S. Nonprovisional Patent Application claims priority to U.S. Provisional Patent Application Ser. No. 61/032,300, filed Feb. 28, 2008, entitled “Low Transfat Margarine.”

### BACKGROUND

Margarine is a water-in-oil emulsion product that resembles butter. It is made from a wide variety of animal or vegetable fats and generally consists of approximately 80% fat blend and approximately 20% aqueous component. Margarine must also contain at least 15,000 IU/kg of vitamin A. Spreads typically contain 40-79% fat. All percentages are weight percentages.

Recently, it has become desirable to reduce the amount of trans fatty acids in food products because of the potential negative health effects associated with trans fatty acids. A low trans fat oil blend that contains low trans fatty acids can be used to make a low trans fat margarine or spread. The terms fat and oil are used interchangeably.

### BRIEF SUMMARY

A low trans fat oil blend is prepared with partially hydrogenated vegetable oil, palm kernel oil and palm oil. The oil blend comprises:
at least about 50% partially hydrogenated vegetable oil having a trans fatty acid content from about 2% to about 8%,
from about 20% to about 50% palm kernel oil, and
from about 5% to about 20% palm oil.

A low trans fat oil blend is prepared with partially hydrogenated corn oil, palm kernel oil and palm oil. The oil blend comprises:
at least about 50% partially hydrogenated corn oil having an Iodine Value from about 114 to about 118,
from about 20% to about 50% palm kernel oil, and
from about 5% to about 20% palm oil.

A margarine comprises:

at least 80% of an oil blend of:
at least about 50% partially hydrogenated vegetable oil having a trans fatty acid content from about 2% to about 8%,
from about 20% to about 50% palm kernel oil, and
from about 5% to about 20% palm oil;

and from about 5% to about 20% aqueous solution.

A margarine comprises:

at least 80% of an oil blend of:
at least about 50% partially hydrogenated corn oil having an Iodine Value from about 114 to about 118,
from about 20% to about 50% palm kernel oil, and
from about 5% to about 20% palm oil;

and from about 5% to about 20% aqueous solution.

A method of making a low trans fat product comprises the steps of:

providing an oil blend, wherein the oil blend comprises: at least 50% partially hydrogenated vegetable oil having a trans fatty acid content from about 2% to about 8%, from about 20% to about 50% palm kernel oil, and from about 5% to about 20% palm oil;

providing an aqueous blend;

combining the oil blend and the aqueous blend.

It is to be understood that both the foregoing general description and the following detailed description are exemplary and explanatory only and are not necessarily restrictive of the invention as claimed.

### DETAILED DESCRIPTION OF THE INVENTION

A low trans fat oil blend comprises partially hydrogenated vegetable oil, palm kernel oil and palm oil. All percentages are weight percentages.

Partially hydrogenated vegetable oil is well known in the art and can be any vegetable oil that is partially hydrogenated and has a trans fatty acid content (as measured using gas chromatography) from about 2% to about 8%. Examples of partially hydrogenated vegetable oils include one or more of partially hydrogenated corn oil, partially hydrogenated soybean oil, partially hydrogenated sunflower oil, partially hydrogenated peanut oil, partially hydrogenated safflower oil and partially hydrogenated canola oil. Other comparable vegetable oils not listed may also be substituted.

Partially hydrogenated vegetable oil can be prepared by reacting the vegetable oil with hydrogen atoms in the presence of a metal catalyst. The unsaturated fatty acids in the vegetable oil have double bonds that are usually in the cis- configuration. With partial hydrogenation, the unsaturated fatty acids can be reconfigured from cis- to trans-configuration.

The traditional measure of the degree of bonds available for the hydrogenation process is given by the ‘Iodine Value’ (IV) and can be determined by adding iodine to the fat or oil. The amount of iodine in grams absorbed per 100 ml of oil is the IV. The higher the IV, the more unsaturated (the greater the number of double bonds) the oil, and generally, the lower the temperature at which the fat or oil solidifies. Lower IV values means the oils are more saturated with fewer double-bonds. Increasing hydrogenation works to lower the IV.

For corn oil, which begins with an IV of about 120-130, hydrogenation should take place until the IV drops to about 114 to about 118, which provides a trans fatty acid content from about 2% to about 8%. Other vegetable oils can be similarly hydrogenated to provide an IV drop sufficient to provide a trans fatty acid content from about 2% to about 8%.

Palm kernel oil is a commodity that is well known in the art. It is a solid fat at room temperature with a melting point near body temperature. Palm kernel oil may be subjected to a fractionation process to segregate the soft (olein) fat from the hard (stearin) fat. Both fats have application in margarine or spreads. In general, palm kernel oil improves setting properties and is very stable against oxidation. Setting properties refer to rate of fat crystallization.

Palm oil is also a commodity that is well known in the art. It imparts the solid content and texture desired for margarine or spreads without the need for hydrogenation, which can produce trans fatty acids. It is semi-solid at room temperature and has a relatively high saturated fat content.

The low trans fat oil blend comprises:
at least about 50% partially hydrogenated vegetable oil having a trans fatty acid content from about 2% to about 8%,
from about 20% to about 50% palm kernel oil, and
from about 5% to about 20% palm oil.

The low trans fat oil blend is prepared by:
providing at least about 50% partially hydrogenated vegetable oil having a trans fatty acid content from about 2% to about 8%, providing from about 20% to about 50% palm kernel oil, and providing from about 5% to about 20% palm oil;
and blending said partially hydrogenated vegetable oil, palm kernel oil and palm oil together.

The oils may be blended in a blend tank. The oil blend may be optionally heated to a temperature to facilitate the blending process or the oils may be melted prior to blending.

Blending takes place until the oil blend is uniform.

A margarine can be prepared comprising:

at least 80% of a low trans fat oil blend of:
at least about 50% partially hydrogenated vegetable oil having a trans fatty acid content from about 2% to about 8%,
from about 20% to about 50% palm kernel oil, and
from about 5% to about 20% palm oil;

and from about 5% to about 20% aqueous solution.

A spread can be prepared comprising:

from about 40% to about 79% of a low trans fat oil blend of:
at least about 50% partially hydrogenated vegetable oil having a trans fatty acid content from about 2% to about 8%,
from about 20% to about 50% palm kernel oil, and
from about 5% to about 20% palm oil;

and from about 21% to about 60% aqueous solution.

The aqueous solution may comprise: edible protein components, emulsifiers, flavoring, color, and vitamins or minerals.

Edible protein components may include whey, albumin, casein, caseinate, or soy protein isolate and may be added up to about 2%.

Emulsifiers are used to hold the fat and water phase together. Example emulsifiers include lecithin and mono- and diglycerides may be added up to about 2%, though two component emulsifier systems are common.

Flavoring materials may include salt or artificial flavors, for e.g., artificial butter flavoring, and may be added up to about 2%.

Margarine must be fortified with at least 15,000 IU/kg of vitamin A. Other vitamins or minerals that may be included in margarine up to about 2% include Vitamins B1, D, E, or iron.

Color additives may vary, but may be added up to about 2%; however, beta carotene is often added for color and for its vitamin A content. Other color additives may include annatto-based products, turmeric or artificial colors.

The margarine and spread are prepared by:
providing a low trans fat oil blend, wherein the oil blend comprises: at least 50% partially hydrogenated vegetable oil having a trans fatty acid content from about 2% to about 8%;
from about 20% to about 50% palm kernel oil; and from about 5% to about 20% palm oil;
providing an aqueous blend;
combining the oil blend and the aqueous blend.

Other processing steps may include: deodorization, emulsification, plasticizing, and tempering.

Deodorization

Deodorization is where the flavors and odors of the oil blend are removed to obtain a bland, odorless oil. It is a vacuum steam distillation process that removes odorous substances, such as, free fatty acids, aldehydes, ketones, peroxides, and alcohols, among other things.

Emulsification

During emulsification, the water-soluble ingredients, which are mixed in a separate vat, and the oil blend are combined. The aqueous phase is dispersed in the oil phase using, for e.g., a shear agitator mixer. The resulting emulsion is continuously agitated and heated to an emulsion temperature of 100±5° F. until the emulsion is uniform and it can persist without separation of the oil and water phase for long periods of time.

Plasticizing

The emulsion is then pumped to a Votator, which is a swept-surface heat exchanger used to plasticize fat. The Votation parameters are listed in Table 1 below. The emulsion is pumped into the first swept-surface heat exchanger known as an A unit, where the fat is supercooled and partially crystallized. The supercooled fat is then pumped to the B units, where the fat is worked by agitation. Here the fat crystals are sheared while the heat of crystallization is dissipated. The fat then may be sent to a filling unit for packaging.

TABLE 1

| | |
|---|---|
| Marbase Temperature | 125 +/− 5° F. |
| Milk Temperature | 45 +/− 5° F. |
| Emulsion Temperature | 100 +/− 5° F. |
| % Nitrogen | none |
| A-Unit Temperature | 60 +/− 2 F. |
| B-Unit Temperature | 70 +/− 2 F. |

Tempering

After plasticizing and packaging, the margarine is tempered. During tempering, fat crystals change from one crystalline form to another more stable form—a phenomenon known as polymorphism. Tempering expedites transformation of crystals to its more stable form. Tempering also causes the fat to become slightly firmer above tempering temperatures and slightly softer at temperatures below the tempering temp—thus, tempering serves to extend the plastic range of margarine. Tempering is carried out at 45+/−5° F. for 48 hours.

### EXAMPLE 1

A low trans fat oil blend comprising partially hydrogenated vegetable oil, palm kernel oil and palm oil is blended together using the method described above in the following proportions:

| | |
|---|---|
| partially hydrogenated vegetable oil | about 52.0% |
| palm kernel oil | about 33.0% |
| palm oil | about 15.0%, |

the partially hydrogenated vegetable oil having a trans fatty acid content from about 2% to about 8%.

The oils are blended until the blend is uniform and meets the specifications listed below in Table 2.

TABLE 2

| Color, Lovibond Red | | 3.5 max |
|---|---|---|
| Free Fatty Acid | | 0.05% max |
| Peroxide Value | | 1.0 max |
| Solid Fat Index @ | 50 F. | from about 19 to about 25 |
| | 70 F. | from about 8 to about 14 |
| | 92 F. | 5 max |

| | |
|---|---|
| Trans Fatty Acids (by GC) | from about 2.0% to about 3.5% |
| Target Nutritional Values: | |
| Saturated Fatty Acids | from about 40% to about 60% |
| Polyunsaturated Fatty Acids | from about 16% to about 36% |
| Monounsaturated Fatty Acids | from about 11% to about 31% |

### EXAMPLE 2

A low trans fat oil blend comprising partially hydrogenated corn oil, palm kernel oil and palm oil is blended together using the method described above in the following proportions:

| | |
|---|---|
| partially hydrogenated corn oil | about 52.0% |
| palm kernel oil | about 33.0% |
| palm oil | about 15.0%, |

the partially hydrogenated corn oil having an Iodine Value from about 114 to about 118 and a trans fatty acid content from about 2% to about 8%.

### EXAMPLE 3

A margarine is prepared comprising:
(1) at least 80% of a low trans fat oil blend of:

| | |
|---|---|
| partially hydrogenated corn oil | about 52.0% |
| palm kernel oil | about 33.0% |
| palm oil | about 15.0%, |

the partially hydrogenated corn oil having a trans fatty acid content from about 2% to about 8% and an IV from about 114 to about 118;
(2) and from about 5% to about 20% aqueous solution.

### EXAMPLE 4

A margarine is prepared comprising:
(1) at least 80% of a low trans fat oil blend of:

| | |
|---|---|
| partially hydrogenated corn oil | at least about 50% |
| palm kernel oil | from about 20% to about 50% |
| palm oil | from about 5% to about 20%, |

the partially hydrogenated corn oil having a trans fatty acid content from about 2% to about 8% and an IV from about 114 to about 118;
(2) and an aqueous solution comprising:

| from about 5% to about 20% | water |
|---|---|
| <2% | salt |
| <2% | whey |
| <2% | soy lecithin |
| <2% | mono- and diglycerides |
| <2% | sodium benzoate |
| <2% | vitamin A |
| <2% | artificial color (beta carotene) |
| <2% | artificial flavor. |

In the above examples, the finished margarine meets the following specifications listed in Table 3:

TABLE 3

| | |
|---|---|
| Fat | at least about 80.0% |
| Moisture | from about 17.2% to about 17.8% |
| Salt | from about 1.4% to about 1.8% |
| Trans Fatty Acid | from about 1.5% to about 3.2% |

### EXAMPLE 5

A spread is prepared comprising:
(1) from about 40% to about 79% of a low trans fat oil blend of:

| | |
|---|---|
| partially hydrogenated vegetable oil | about 52.0% |
| palm kernel oil | about 33.0% |
| palm oil | about 15.0%, |

the partially hydrogenated vegetable oil having a trans fatty acid content from about 2% to about 8%
(2) and from about 21% to about 60% aqueous solution.

The partially hydrogenated vegetable oil may be replaced by partially hydrogenated corn oil having a Iodine Value from about 114 to about 118 and a trans fatty acid content from about 2% to about 8%

What is claimed is:

1. A low trans fat oil blend comprising: at least about 50% partially hydrogenated vegetable oil, from about 20% to about 50% palm kernel oil, and from about 5% to about 20% palm oil, wherein the partially hydrogenated vegetable oil has a trans fatty acid content from about 2% to about 8%.

2. The oil blend of claim 1, wherein the partially hydrogenated vegetable oil is one or more of partially hydrogenated corn oil, partially hydrogenated soybean oil, partially hydrogenated sunflower oil, partially hydrogenated peanut oil, partially hydrogenated safflower oil and partially hydrogenated canola oil.

3. The oil blend of claim 1, wherein the partially hydrogenated vegetable oil is partially hydrogenated corn oil.

4. The oil blend of claim 3, wherein the partially hydrogenated corn oil has an iodine value from about 114 to about 118.

5. The oil blend of claim 1, comprising about 52.0% hydrogenated vegetable oil, about 33.0% palm kernel oil, and about 15.0% palm oil.

6. The oil blend of claim 1, wherein the trans fatty acid content is from about 2.0% to about 3.5%.

7. A margarine comprising: at least about 80% of the oil blend of claim 1 and from about 5% to about 20% aqueous solution.

8. The margarine according to claim 7, wherein the margarine further comprises one or more additional ingredients selected from the group consisting of: emulsifiers, coloring agents, flavoring agents, vitamins, and water.

9. The margarine according to claim 7, wherein the trans fatty acid content is from about 1.5% to about 3.2%.

10. A spread comprising: from about 40% to about 79% of the oil blend of claim 1 and from about 21% to about 60% aqueous solution.

11. A low trans fat oil blend comprising: at least about 50% partially hydrogenated corn oil having an Iodine Value from about 114 to about 118, from about 20% to about 50% palm kernel oil, and from about 5% to about 20% palm oil.

12. The oil blend of claim 10, comprising about 52.0% hydrogenated vegetable oil, about 33.0% palm kernel oil, and about 15.0% palm oil.

13. The oil blend of claim 10, wherein the trans fatty acid content is from about 2.0% to about 3.5%.

14. A margarine comprising: at least about 80% of the oil blend of claim 10 and from about 5% to about 20% aqueous solution.

15. The margarine according to claim 15, wherein the margarine further comprises one or more additional ingredients selected from the group consisting of: emulsifiers, coloring agents, flavoring agents, vitamins, and water.

16. The margarine according to claim 15, wherein the trans fatty acid content is from about 1.5% to about 3.2%.

17. A spread comprising: from about 40% to about 79% of the oil blend of claim 10 and from about 21% to about 60% aqueous solution.

18. A method of making a low trans fat product comprising:
a. providing an oil blend, wherein the oil blend comprises: at least 50% partially hydrogenated vegetable oil having a trans fatty acid content from about 2% to about 8%, from about 20% to about 50% palm kernel oil, and from about 5% to about 20% palm oil;
b. providing an aqueous blend;
c. combining the oil blend and the aqueous blend.
